(19) United States
(12) Patent Application Publication
(10) Pub. No.: US 2016/0048734 A1
(43) Pub. Date: Feb. 18, 2016

(54) LIGHT SOURCE RECOGNITION SYSTEM OF VEHICLE

(71) Applicant: HYUNDAI MOBIS Co., Ltd., Yongin-si (KR)

(72) Inventors: Hyuk Lee, Yongin-si (KR); Hyun Jin PARK, Yongin-si (KR)

(21) Appl. No.: 14/810,341

(22) Filed: Jul. 27, 2015

(30) Foreign Application Priority Data
Aug. 13, 2014 (KR) 10-2014-0105095

(51) Int. Cl. G06K 9/00; B60Q 1/14; B60Q 1/08; B60R 1/00; G06K 9/32

(52) U.S. Cl. CPC G06K 9/00825; B60R 1/00; G06K 9/3233; B60Q 1/08; B60Q 1/143; B60R 2300/307; B60R 2300/80

(57) ABSTRACT

Provided is a light source recognition system of a vehicle, including: a camera sensor module which generates raw data for a front image of a vehicle; a light source determining module which analyzes the raw data to determine whether a light source is present in the front image and when the light source is present, sets a region of the front image where the light source is represented as a region of interest; a compressing module which compresses data corresponding to the region of interest among the raw data without losing data and compresses the data corresponding to a region excluding the region of interest, among the raw data, with a loss of data so that the raw data is converted into compressed data; and a control module which decompresses the compressed data to convert the compressed data into the raw data, recognizes the light source from the region of interest set in the front image using the decompressed raw data, generates a control signal corresponding to the light source, and controls the camera sensor module, the light source determining module, and the compressing module.

### CROSS-REFERENCE TO RELATED APPLICATIONS

The present application claims priority to Korean Patent Application Number 10-2014-0105095 filed Aug. 13, 2014, the entire contents of which application is incorporated herein for all purposes by this reference.

### TECHNICAL FIELD

The present invention relates to a light source recognition system of a vehicle, and more particularly, to a light source recognition system of a vehicle which easily recognizes a light source included in a front image which is photographed by a camera sensor module.

### BACKGROUND

For providing necessary safety features in a vehicle, in the related art, passive safety systems such as an airbag, a seat belt, and an anti-lock braking system (ABS) have been used a lot. When the passive safety system is combined with an active safety system which prevents collision in advance, collision is prevented, so that safety for a driver and a passenger may be secured. As a representative example, a forward collision warning system (FCWS) functions to prevent collision with a forward vehicle.

Functions such as FCWS, a lane keeping assist system (LKAS), adaptive cruise control (ACC), and an adaptive front light system (AFLS) are employed in an advanced safety vehicle.

In an ASV field, a camera which is provided in the vehicle is used for various purposes and a front image obtained from the camera is used to recognize a forward vehicle or an oncoming vehicle in an opposite direction. For example, according to a high beam assist (HBA) technology, tail lights or head lights of the forward vehicle or the oncoming vehicle in an opposite direction are recognized at night to control high beams of a user's vehicle.

Recently, a study has progressed in order to allow easy recognition of a light source of another vehicle included in a front image which is obtained from the camera.

### SUMMARY

The present invention has been made in an effort to provide a light source recognition system of a vehicle which easily recognizes a light source included in raw data photographed by a camera sensor module.

An exemplary embodiment of the present invention provides a light source recognition system of a vehicle, including: a camera sensor module which generates raw data for a front image of a vehicle; a light source determining module which analyzes the raw data to determine whether a light source is present in the front image and when the light source is present, sets a region of the front image where the light source is represented as a region of interest; a compressing module which compresses data corresponding to the region of interest among the raw data without losing data and compresses the data corresponding to a region excluding the region of interest, among the raw data, with a loss of data so that the raw data is converted into compressed data; and a control module which decompresses the compressed data to convert the compressed data into the raw data, recognizes the light source from the region of interest set in the front image using the decompressed raw data, generates a control signal corresponding to the light source, and controls the camera sensor module, the light source determining module, and the compressing module.

The camera module may include: at least one image sensor and generate a plurality of raw data for front images having different brightnesses in accordance with a time, based on a signal output from at least one image sensor.

The light source determining module may include an image selecting unit which selects raw data for the front image which is photographed under a predetermined exposure condition, among the raw data, in order to recognize the light source; a brightness determining unit which determines whether the light source is present based on presence of a region having a brightness which exceeds a predetermined threshold value, in the front image corresponding to the selected raw data; and a region setting unit which sets the region of interest including the light source in the raw data when the light source is present.

The raw data may be raw data for a front image which is photographed under an exposure condition in which an intensity of light which is incident onto the camera sensor module is lowest.

The brightness determining unit may determine that the light source is present in the front image when there is a part having a brightness value for every pixel of the front image corresponding to the raw data which is larger than the threshold value.

When a pattern of the pixel having a brightness value which is larger than the threshold value satisfies a predetermined light source pattern, the brightness determining unit may determine that the light source is present in the front image. The system may further include a storing unit which stores the compressed data.

The control module may recognize the region of interest set in the front image for the decompressed raw data to determine which one of a lane, an oncoming vehicle in an opposite direction, and a forward vehicle corresponds to the light source.

The system may further include a display module which displays the front image for the decompressed raw data in accordance with the control of the control module.

Further, the control module may generate the control signal, based on a size or a position of the light source which is recognized using the decompressed raw data.

When it is determined that the light source which is recognized using the decompressed raw data is a light source from another forward vehicle, the control module may generate the control signal and the control signal may be a signal which downwardly adjusts an illumination angle of a high beam provided in the vehicle or turns off the high beam.

A light source recognition system of a vehicle according to an exemplary embodiment of the present invention recognizes a light source by arbitrary raw data for recognizing a light source, among a plurality of raw data photographed by changing an exposure condition of a camera sensor module to set a light source candidate region in the plurality of raw data including a light source recognized from arbitrary raw data, thereby compressing the light source candidate area in a process of compressing the plurality of raw data without losing data. Therefore, when the plurality of compressed raw data is decompressed, the light source may be easily recognized.

According to the light source recognizing system of a vehicle according to the exemplary embodiment of the present invention, the light source is easily recognized so that a lane, a forward vehicle, and an oncoming vehicle in an opposite direction may be distinguished.

### BRIEF DESCRIPTION OF THE DRAWINGS

FIG. 1 is a control block diagram illustrating a control configuration for a light source recognition system of a vehicle according to an exemplary embodiment of the present invention.

FIG. 2 is a control block diagram illustrating a control configuration of a light source determining module illustrated in FIG. 1.

### DETAILED DESCRIPTION

Advantages and characteristics of the present invention and a method of achieving the advantages and characteristics will be clear by referring to exemplary embodiments described below in detail together with the accompanying drawings. However, the present invention is not limited to exemplary embodiments disclosed herein but will be implemented in various different forms. The exemplary embodiments are provided only by way of example only so that a person with ordinary skill in the art can fully understand the disclosures of the present invention and the scope of the present invention. Therefore, the present invention will be defined only by the scope of the appended claims. Like reference numerals indicate like elements throughout the specification.

Unless otherwise defined, all terms (including technical and scientific terms) used in the present specification may be used as the meaning which may be commonly understood by the person with ordinary skill in the art, to which the present invention pertains. It will be further understood that terms defined in commonly used dictionaries should not be interpreted to have an idealistic or excessively formalistic meaning unless expressly and specifically defined.

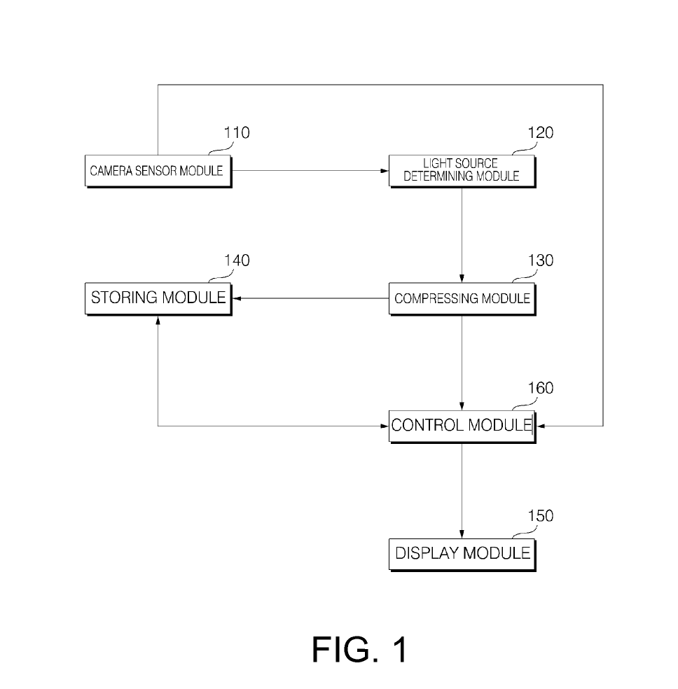

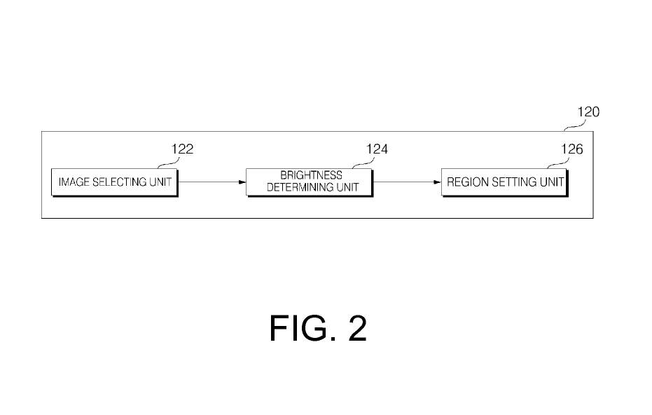

FIG. 1 is a control block diagram illustrating a control configuration for a light source recognition system of a vehicle according to an exemplary embodiment of the present invention and FIG. 2 is a control block diagram illustrating a control configuration of a light source determining module illustrated in FIG. 1.

Referring to FIGS. 1 and 2, a light source recognition system of a vehicle may include a camera sensor module 110, a light source determining module 120, a compressing module 130, a storing module 140, a display module 150, and a control module 160.

The camera sensor module 110 may include at least one image sensor. For example, the image sensor may be at least any one of a CCD sensor and a CIS sensor, but the present invention is not limited thereto. The camera sensor module 110 photographs a front of the vehicle in accordance with control of the control module 160 to generate a front image. That is, the camera sensor module 110 may generate raw data for the front image.

The camera sensor module 110 may time-continuously change an exposure condition or change an exposure condition at a predetermined time interval, but the present invention is not limited thereto. Here, the exposure condition may refer to at least one of various conditions which may affect generation of the front image. For example, the exposure condition may refer to an opening degree of a diaphragm provided in the camera sensor module 110 or a shutter speed. For example, the control module 160 may change the exposure condition such that a shutter speed at night is slower than a shutter speed during the day time.

When the exposure condition is changed, intensity or an amount of light which is incident onto the camera sensor module 110 varies and thus a brightness of the front image which is generated by the camera sensor module 110 may also vary.

The camera sensor module 110 may output different signals in accordance with a change in the intensity or the amount of light which is incident onto at least one image sensor. The camera sensor module 110 may generate raw data for front images having different brightnesses, based on a signal output from the image sensor.

In the exemplary embodiment, front images for the plurality of raw data are images having different brightnesses.

The camera sensor module 110 may sequentially transmit the plurality of raw data to the light source determining module 120 in accordance with a time when the plurality of raw data is generated.

The light source determining module 120 may analyze the raw data to determine whether a light source is present in the front image and when the light source is present, set a region of the front image where the light source is represented as a region of interest.

The light source determining module 120 may include an image selecting unit 122, a brightness determining unit 124, and a region setting unit 126.

The image selecting unit 122 may select raw data for a front image which is photographed in a predetermined exposure condition, among the plurality of raw data which is sequentially input from the camera sensor module 110 in accordance with the time.

The image selecting unit 122 may sequentially temporarily store the plurality of raw data and select specific raw data from the plurality of raw data.

For example, raw data which is selected by the image selecting unit 122 may be raw data for a front image which is photographed under an exposure condition in which intensity of light which is incident onto the camera sensor module 110 is lowest, but the present invention is not limited thereto.

The brightness determining unit 124 determines whether the light source is present, based on whether the front image corresponding to the raw data selected by the image selecting unit 122 has a region having a brightness which exceeds a predetermined threshold value.

The brightness determining unit 124 compares a brightness value of the raw data selected by the image selecting unit 122 with a predetermined threshold value to determine whether the light source is present.

That is, the brightness determining unit 124 may detect pixels having a brightness value which is larger than the threshold value, among a plurality of pixels (not illustrated) which forms the front image corresponding to the raw data.

Thereafter, the brightness determining unit 124 may determine whether the light source is present in accordance with a concentration degree of pixels having a brightness value which is larger than the threshold value. For example, when a pattern of pixels having a brightness value which is larger than the threshold value satisfies a predetermined light source pattern, the brightness determining unit 124 may determine that the light source is present in the front image.

When it is determined that the light source is present, the brightness determining unit 124 may output a signal indicating that the light source is present in the front image corresponding to the raw data.

When the raw data and the signal indicating that the light source is present are input from the brightness determining unit 124, the region setting unit 126 may determine that the light source is present in the raw data. Thereafter, the region setting unit 126 may set a region of interest in the front image corresponding to the raw data. In this case, the region setting unit 126 may set a region of interest including a region where the light source is present. For example, in the region of interest, only the light source is included or a part of surrounding regions enclosing the light source may be further included. In this case, the region setting unit 126 allows the light source candidate region to include the surrounding region set based on the brightest pixel so as to easily recognize the light source, but the present invention is not limited thereto.

The compressing module 130 compresses data corresponding to the region of interest among the raw data without losing data and compresses the data corresponding to a region excluding the region of interest, among the raw data, with a loss of data so that the raw data is converted into compressed data.

When at least one raw data is input from the light source determining module 120, the compressing module 130 determines whether a region of interest is set in each raw data.

Thereafter, when the light source candidate region is set, the compressing module 130 may compress the region of interest without losing data and normally compress a background region other than the region of interest. Here, the normal compression may refer to any one of compression with a loss of data and compression without losing data.

The compressing module 130 may output compressed data which is compressed raw data, as described above.

The storing module 140 may store raw data in which the region of interest is set and compressed data which is output from the compressing module 130.

The storing module 140 may transmit the compressed data to the control module 130 in accordance with control of the control module 160, but the present invention is not limited thereto.

The display module 150 may display the raw data in accordance with the control of the control module 160. In this case, the control module 130 may eliminate the light source or the light source candidate region which is present in the raw data displayed on the display module 150, but the present invention is not limited thereto.

The control module 160 decompresses the compression of the compressed data to convert the compressed data into the raw data. The control module 160 may recognize the light source from the region of interest which is set in the front image using the raw data which is decompressed. Further, the control module 160 may generate a control signal corresponding to the recognized light source. Further, the control module 160 controls overall operations of the camera sensor module, the light source determining module, and the compressing module.

When the compressed data which is output from the compressing module 130 is input, the control module 160 decompresses the compression which is applied to the compressed data to obtain raw data and analyzes the obtained raw data to recognize the light source. In this case, the display module may display the front image for the decompressed raw data in accordance with the control of the control module.

When it is determined that the recognized light source is a light source from at least one of a lane, a forward vehicle, and an oncoming vehicle in an opposite direction, the control module 160 may control the front image where the light source is present to be displayed on the display module 150.

When the recognized light source is a reflected light source, for example, an unnecessary light source, such as a light source reflected onto the road, the control module 160 may eliminate the unnecessary light source from the plurality of raw data to be displayed on the display module 150.

The control module 160 may generate the control signal, based on a size or a position of the light source which is recognized using the decompressed raw data. For example, when it is determined that the light source which is recognized using the decompressed raw data is a light source from another forward vehicle, the control module may generate the control signal.

In this case, the control signal may be a signal which downwardly adjusts an illumination angle of a high beam provided in the vehicle or turns off the high beam. For example, when the recognized light source corresponds to the predetermined size and a position pattern of the lamp of the oncoming vehicle in the opposite direction, the control module 160 may output a control signal which downwardly adjusts the illumination angle of the high beam to an illumination control system (not illustrated) provided in the vehicle.

The word “comprise”, “configure”, or “have” used in the above description will be understood to imply the inclusion of stated elements unless explicitly described to the contrary, so that the word will be interpreted to imply the inclusion of stated elements but not the exclusion of any other elements.

The exemplary embodiments of the present invention have been illustrated and described above, but the present invention is not limited to the above-described specific embodiments, it is obvious that various modifications may be made by those skilled in the art, to which the present invention pertains without departing from the gist of the present invention, which is claimed in the claims, and such modifications should not be individually understood from the technical spirit or prospect of the present invention.

What is claimed is:

1. A lamp recognition system of a vehicle, comprising:
a camera sensor module which generates raw data for a front image of a vehicle;
a light source determining module which analyzes the raw data to determine whether a light source is present in the front image and when the light source is present, sets a region of the front image where the light source is represented as a region of interest;
a compressing module which compresses data corresponding to the region of interest among the raw data without losing data and compresses the data corresponding to a region excluding the region of interest, among the raw data, with a loss of data so that the raw data is converted into compressed data; and
a control module which decompresses the compressed data to convert the compressed data into the raw data, recognizes the light source from the region of interest set in the front image using the decompressed raw data, generates a control signal corresponding to the light source, and controls the camera sensor module, the light source determining module, and the compressing module.

2. The system of claim 1, wherein the camera sensor module includes at least one image sensor and generates a plurality of raw data for front images having different brightness in accordance with a time, based on a signal output from the at least one image sensor.

3. The system of claim 1, wherein the light source determining module includes:
an image selecting unit which selects raw data for the front image which is photographed under a predetermined exposure condition, among the raw data, in order to recognize the light source;
a brightness determining unit which determines whether the light source is present based on presence of a region having a brightness which exceeds a predetermined threshold value, in the front image corresponding to the selected raw data; and
a region setting unit which sets the region of interest including the light source in the raw data when the light source is present.

4. The system of claim 3, wherein the raw data is raw data for a front image which is photographed under an exposure condition in which an intensity of light which is incident onto the camera sensor module is lowest.

5. The system of claim 3, wherein the brightness determining unit determines that the light source is present in the front image when there is a part having a brightness value for every pixel of the front image corresponding to the raw data which is larger than the threshold value.

6. The system of claim 5, wherein when a pattern of the pixel having a brightness value which is larger than the threshold value satisfies a predetermined light source pattern, the brightness determining unit determines that the light source is present in the front image.

7. The system of claim 1, further comprising:
a storing module which stores the compressed data.

8. The system of claim 1, wherein the control module recognizes the region of interest set in the front image for the decompressed raw data to determine which one of a lane, an oncoming vehicle in an opposite direction, and a forward vehicle corresponds to the light source.

9. The system of claim 1, further comprising:
a display module which displays a front image for the decompressed raw data in accordance with control of the control module.

10. The system of claim 1, wherein the control module generates the control signal based on a size or a position of the light source which is recognized using the decompressed raw data.

11. The system of claim 10, wherein, when it is determined that the light source recognized using the decompressed raw data is a light source from another forward vehicle, the control module generates the control signal, and
the control signal is a signal which downwardly adjusts an illumination angle of a high beam provided in the vehicle or turns off the high beam.
